(19) United States
(12) Patent Application Publication
(10) Pub. No.: US 2017/0105517 A1
(43) Pub. Date: Apr. 20, 2017

(54) DISPOSABLE TOOTHBRUSH AND FLOSSING DEVICE

(71) Applicants: Dimitriy Petrov, Tullahoma, TN (US); Zack Isaacs, Knoxville, TN (US)

(72) Inventors: Dimitriy Petrov, Tullahoma, TN (US); Zack Isaacs, Knoxville, TN (US)

(21) Appl. No.: 14/886,866

(22) Filed: Oct. 19, 2015

(51) Int. Cl. A46B 15/00; A61C 15/04; A46B 11/00; A61C 15/02; A46B 9/04; A46B 5/02

(52) U.S. Cl. CPC A46B 15/0071; A46B 9/04; A46B 15/0081; A46B 5/021; A46B 11/0003; A61C 15/02; A61C 15/046; A46B 2200/1066

(57) ABSTRACT

A combined toothbrush and mouth care device includes a main body member having a proximal end and a distal end, a brush head having a plurality of bristles to brush a user's teeth coupled to the proximal end of the main body member and a flossing member to floss between the user's teeth integrally formed with the distal end of the main body member, wherein the brush head includes a first region having a first width and a second region having a second width less than the first width to reach the user's posterior teeth.

### FIELD OF INVENTION

The present general inventive concept relates to an oral care device, and in particular, to a portable toothbrush/flosser device having an integrated toothbrush, flosser, and tongue scraper for improved dental hygiene and mouth care.

### BACKGROUND

Brushing ones teeth and flossing regularly is known to promote healthy teeth and gums. Over the years, various types of dental hygiene devices have been developed to help reduce or prevent dental and periodontal related diseases. Some of these devices combine a tooth brush with a flossing device in order to provide a convenient tool for maintaining ones oral hygiene even while travelling.

Although some conventional teeth cleaning tools integrate a flossing tool with a toothbrush head, they are less than satisfactory in providing a compact ergonomic disposable design with an integrated brush and flosser configured to provide a wide brushing area to easily reach a user's posterior teeth at a prime brushing angle, and to wedge within a user's mouth to effectively and efficiently clean all areas within the user's mouth, while reducing an overall amount of time to brush, and providing convenient ergonomic gripping configurations for prime flossing angles.

### BRIEF SUMMARY

Example embodiments of the present general inventive concept may be achieved by providing a combined toothbrush and mouth care device which includes a main body member having a proximal end and a distal end, a brush head having a plurality of bristles to brush a user's teeth coupled to the proximal end of the main body member and a flossing member to floss between the user's teeth integrally formed with the distal end of the main body member, wherein the brush head includes a first region having a first width and a second region having a second width less than the first width to reach the user's posterior teeth.

The brush head may be formed in a triangular shape with rounded corner portions.

The first region of the brush head may be configured to simultaneously contact upper and lower sets of teeth of the user.

The second region of the brush head may be configured to wedge within the user's mouth to contact the user's posterior teeth.

The plurality of bristles may be arranged in a pattern corresponding to a shape of the brush head.

The plurality of bristles may be coated with a cleaning agent during a manufacturing process.

The plurality of bristles may be disposed on a first surface of the brush head and a tongue cleaner may be formed on an opposing second surface of the brush head to clean a user's tongue.

The tongue cleaner may also be coated with a cleaning agent during a manufacturing process.

The flossing member may include a first arm member, a second arm member, and a dental floss coupled between the first and second arm members.

The first arm member and the second arm member may extend along an elliptical path centered on a centerline of the brush head and the main body member.

The first arm member may extend beyond a centerline of the elliptical path and the second arm member may extend beyond a focal point of the elliptical path.

The main body member may be configured to separate into a first portion including the brush head and a second portion including the flossing member.

The second portion may include a tooth-pick member capable of removing debris from between the user's teeth.

The first portion may include a tooth-pick receiver configured to receive the tooth-pick member.

Additional features and embodiments of the present general inventive concept will be apparent from the following detailed description, drawings, and claims.

### BRIEF DESCRIPTION OF THE FIGURES

The following example embodiments are representative of example techniques and structures designed to carry out the objectives of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a front perspective view of a combined toothbrush and mouth care device according to an example embodiment of the present general inventive concept;

FIG. 2 is a top plan view of the combined toothbrush and mouth care device illustrated in FIG. 1;

FIG. 3 is a rotated bottom plan view of the combined toothbrush and mouth care device illustrated in FIG. 1;

FIG. 4 is a side view of the combined toothbrush and mouth care device illustrated in FIG. 1;

FIG. 5A is a partial cross-sectional view of a user's upper and lower sets of teeth and a combined toothbrush and mouth care device according to an example embodiment of the present general inventive concept;

FIG. 5B is a partial cross-sectional view of the combined toothbrush and mouth care device illustrated in FIG. 5A partially inserted into a user's upper and lower sets of teeth;

FIG. 5C is a partial cross-sectional view of the combined toothbrush and mouth care device illustrated in FIG. 5A fully inserted into a user's upper and lower sets of teeth;

FIG. 6A is a front perspective view of a combined toothbrush and mouth care device according to another example embodiment of the present general inventive concept, in a compressed state;

FIG. 6B is a front perspective view of the combined toothbrush and mouth care device illustrated in FIG. 6A, in an expanded state;

FIG. 6C is an expanded detail view of item A illustrated in FIG. 6B;

FIG. 6D is a front perspective view of a combined toothbrush and mouth care device according to another example embodiment of the present general inventive concept, in an opened state; and

FIG. 6E is a front perspective view of the combined toothbrush and mouth care device illustrated in FIG. 6D, in a closed state.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein. Numerous variations, modification, and additional embodiments are possible, and, accordingly, all such variations, modifications, and embodiments are to be regarded as being within the spirit and scope of the present general inventive concept.

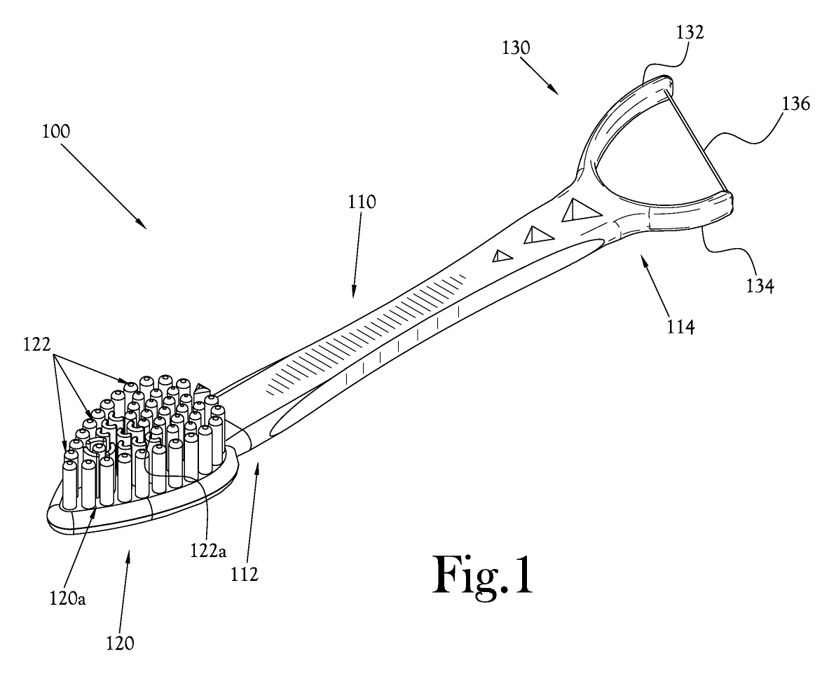

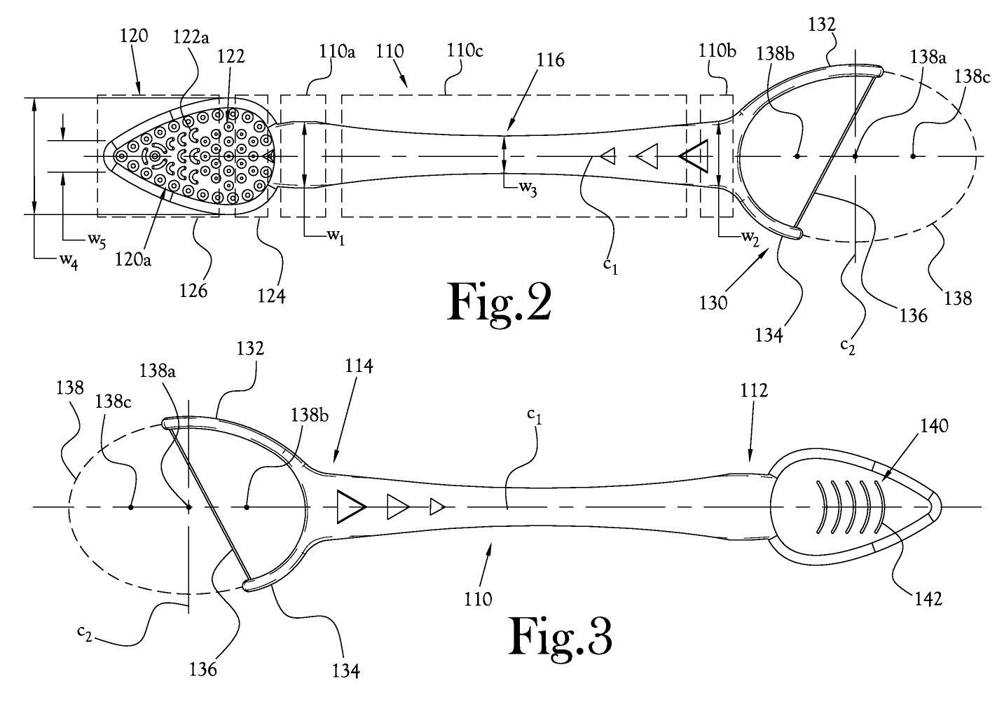

FIG. 1 is a front perspective view of a combined toothbrush and mouth care device 100 according to an example embodiment of the present general inventive concept. FIG. 2 is a top plan view of the combined toothbrush and mouth care device 100 illustrated in FIG. 1.

Referring to FIG. 1, in an example embodiment of the present general inventive concept the combined toothbrush and mouth care device, described generally herein with reference numeral 100, includes an elongated main body member 110 having a proximal end 112 and a distal end 114; a brush head 120 having a plurality of bristles 122 used to clean plaque and tarter from a user's teeth which is coupled to the proximal end 112 of the main body member 110; and a flossing member 130 having a first arm member 132 and a second arm member 134 extending from the distal end 114 of the main body member 110.

Referring to FIG. 2, in example embodiments, the main body member 110 may be formed in an elongated flat shape having a rectangular cross-section and constructed from a plastic material. However, the present general inventive concept is not limited thereto. That is, in example embodiments, the main body member 110 may be formed having various cross-sectional shapes along a longitudinal length and/or width of the main body member 110, including a circular, triangular, and/or polygonal shape, and may be constructed from various materials.

In the present example embodiment, the main body member 110 includes a first portion 110a disposed near the distal end 112, a second portion 110b disposed near the proximal end 114, and a third portion 110c disposed between the first and second portions 110a, 110b. The main body member 110 may further include an ergonomically designed grip portion 116 disposed between the proximal end 112 and the distal end 114 of the main body member 116. The grip portion 116 is configured to allow the user to grip one end of the main body member 110, while still having a full range of motion of the opposite end in order to effectively reach and clean the user's posterior teeth, tongue, and/or other areas within the user's mouth. In example embodiments, the first, second, and third portions 110a, 110b, and 110c respectively have widths W1, W2, and W3 across a width direction of the main body member 110 in FIG. 2. In addition, the main body member 116 and brush head 120 may be symmetric across a centerline C1 extending along the longitudinal length of the main body member 116.

In some example embodiments, the width W3 of the third portion 110c is less than the widths W1 and W2 of the first and second portions 110a, 110b. That is, a central portion of the main body member 110 (i.e., third portion 110c) can be designed to be thinner than the first and second portions 110a, 110b so as to provide a user with greater control and maneuverability of the brush head 120 and the flossing member 130 while brushing or flossing.

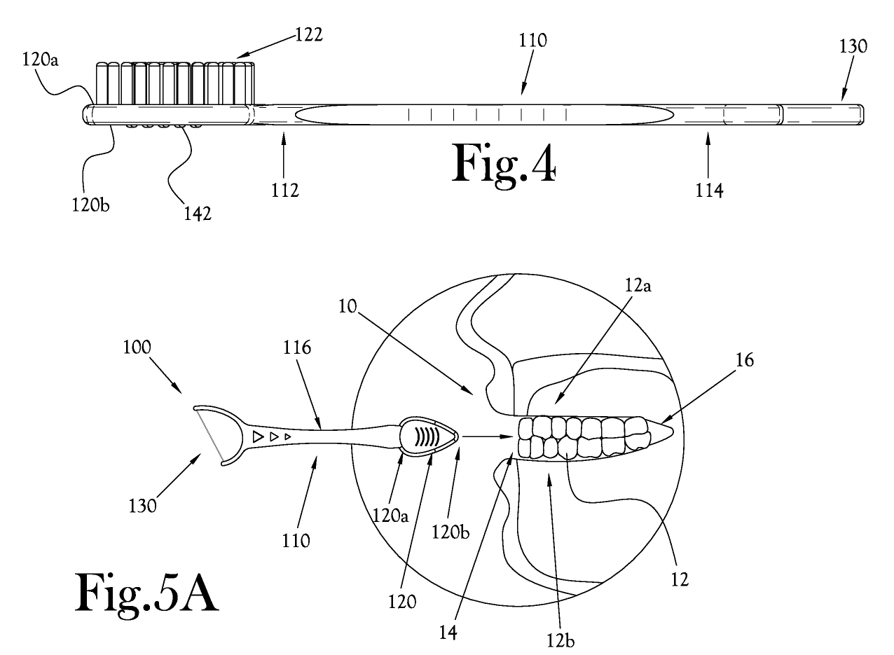

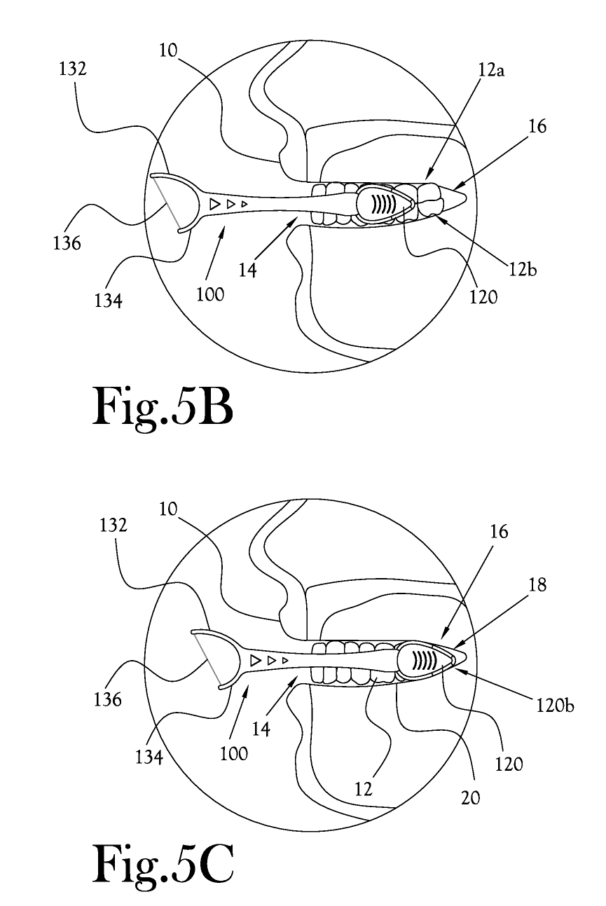

FIG. 3 is a rotated bottom plan view of the combined toothbrush and mouth care device 100 illustrated in FIG. 1 and FIG. 4 is a side view of the combined toothbrush and mouth care device 100 illustrated in FIG. 1.

Referring to FIGS. 3 and 4, the brush head 120 having a first surface 120a and an opposing second surface 120b can be integrally formed with the proximal end 112 of the main body member 110, and the flossing member 130 having a first arm member 132 and a second arm member 134 can be integrally formed with the distal end 114 of the main body member 110. In the present example embodiment, the brush head 120 is formed in an elongated triangular or V-shape. However, the present general inventive concept is not limited thereto.

The plurality of bristles 122 can be coupled to the first surface 120a of the brush head 120 in a triangular or V-shaped pattern to thereby maximize a bristle 122 density coupled to the brush head 120. The plurality of bristles 122 may be used to clean plaque, tarter, and/or other debris from the user's posterior and anterior teeth, while brushing. In example embodiments, the plurality of bristles 122 may be arranged in a pattern corresponding to or matching a shape of the brush head 120. The plurality of bristles 122 may extend outward from the first surface 120a of the brush head 120 to facilitate and assist in cleaning a user's upper and lower sets of teeth. The plurality of bristles 122 may be constructed from a material having sufficient rigidity so as to effectively remove plaque and/or tartar from the user's teeth, while at the same time being resilient enough to avoid injury to the user's teeth and gums. In addition, a density of bristles 122 disposed on the first surface 120a of the brush head 120 provides for less elasticity and more resistance against pressure. Bristles 122 disposed on outer portions of the brush head 120 may be used to break up plaque and larger particles from the users' teeth, while bristles 122 disposed within an inner portion of the brush head 120 may gently polish the user's teeth.

In the present example embodiment, some of the plurality of bristles 122a may be formed in an arc-shape and disposed in a criss-cross or other pattern on the brush head 120. The arc-shaped bristles 122a and the placement pattern of the present inventive concept provide for a scrapping like effect on the teeth while brushing which increases an effectiveness of each brushing stroke. In example embodiments, the plurality of bristles 122 may include a set of bristles having various different shapes and sized diameters to thereby create cup-like shapes at the tops of each set of bristles 122.

In alternative example embodiments, the brush head 120 includes a unique pattern of bristles 122 and arc-shaped bristles 122a which allows the user to more effectively breakup, dislodge, and remove plaque and other debris from the user's teeth. That is, the unique pattern of the arc-shaped bristles 122a allows the brush head 120 to capture and dislodge debris from the user's teeth, similar to a tongue scraper. The arc-shaped bristles 122a may be further formed with various widths and/or lengths to more effectively clean the user's teeth. The brush head 120 may further include a patch of smaller diameter bristles 122 adjacent to the arch-shaped bristles 122a to allow for a polishing-type effect on the user's teeth, while brushing. The plurality of bristles 122 may further include a separation between bristles 122 to be capable of spreading apart and moving freely to allow the bristles 122 to contact small recesses within the user's mouth. In addition, the brush head 120 may further include an outer chain of bristles 122 which may be slightly larger than adjacent bristles to more effectively remove plaque and other debris from the user's teeth.

In addition, an overall size (e.g., 4 inches) and width (e.g., 1.5 inches) of the disposable toothbrush and flossing device 100 according to the present general inventive concept provides the user with an effective toothbrush and flosser which may be conveniently stored and carried, while in transit.

In the present example embodiment, the brush head 120 may be formed with a first region 124 having a width W4 which decreases to a width W5 in a second region 120b. The width W4 of the first region 124 allows for a larger amount of bristles 122 to be disposed along a width direction of the brush head 120 to allow the brush head 120 to simultaneously contact a user's upper and lower sets of teeth, while brushing. Thereby in order to increase an efficiency of each brushing stroke.

That is, the brush head 120 can be designed to have a width of bristles 122 in the first region 124 capable of simultaneously or concurrently contacting the user's upper and lower sets of teeth while brushing. As a result, the combined toothbrush and mouth care device 100 according to the present invention reduces an overall amount of time required to brush all of the user's teeth by increasing a surface area of teeth cleaned by the plurality of bristles 122 on each brushing stroke.

In addition, the second region 126 of the brush head 120 can be designed to include a narrower width than the first region 124 to allow the brush head 120 to wedge, fit, or squeeze within the user's mouth in order to reach, contact, and clean the user's posterior teeth. That is, the width W5 in the second region 126 can be specifically designed so as to fit within narrow openings within the user's mouth such as between the user's teeth and cheeks to thereby gradually wedge or move the user's cheeks and/or gums aside to allow the plurality of bristles 122 to contact and clean the posterior teeth, while brushing.

As such, since a width of the brush head 120 gradually decreases from width W4 to width W5 to form a triangular or V-shape, the second region 126 of the brush head 120 is able to reach further back within the user's mouth allowing the bristles 122 to reach, contact, and clean all areas of the user's mouth, including the user's posterior and anterior teeth. As a result, the combined toothbrush and mouth care device 100 according to the present invention more effectively reaches, removes, and cleans dental plaque and tarter from teeth deep within the user's mouth, the combined toothbrush and mouth care device 100 is an effective oral hygiene tool used to prevent or substantially reduce dental and/or periodontal related diseases.

In further example embodiments, the plurality of bristles 122 may be pre-coated with a cleaning agent, such as tooth paste, during a manufacturing process thereof. As such, the toothbrush and mouth care device of the present example embodiment provides a plurality of functions including a toothbrush having toothpaste pre-coated thereon, a flossing device to floss between teeth, and a tongue scraper to clean the user's tongue.

Referring to FIG. 3, the flossing member 130 extends from the distal end 114 of the main body member 110. The flossing member 130 includes a first arm member 132, a second arm member 134, and a dental floss 136 coupled or stretched between the first and second arm members 132, 134 to floss between the user's teeth.

In the present example embodiment, the first and second arm members 132, 134 extend away from the main body member 110 along an elliptical path 138. The first arm member 132 extends in a first direction (e.g., a counter-clockwise direction) along the elliptical path 138 and the second arm member 134 extends in a second direction (e.g., a clockwise direction) along the elliptical path 138.

In example embodiments, a center point 138a of the elliptical path 138 intersects or coincides with the centerline C1 of the main body member 116 and the brush head 120. In further example embodiments, a first focal point 138b and a second focal point 138c of the elliptical path may also intersect with the centerline C1. However, the present general inventive concept is not limited thereto.

In the present example embodiment, the first arm member 132 extends beyond a centerline C2 of the elliptical path 138 and the second arm member 134 extends beyond the first focal point 138b of the elliptical path 138. In addition, in alternative example embodiments, the first and second arm members 132, 134 may extend beyond the centerline C2 of the elliptical path 138. However, the present general inventive concept is not limited thereto. That is, in alternative example embodiments, the first and second arm members 132, 134 of the flossing member 130 may extend in various arc-shaped or circular paths.

In yet further alternative example embodiments, the brush head 120 may further include a tongue cleaner 140 formed on the second surface 120b of the brush head 120 which may be used to scrape, remove, and/or otherwise clean debris from the user's tongue. The tongue cleaner 140 may include a series of protrusions 142 which extend from the second surface 120b of the brush head 120. In the present example embodiment, the protrusions 142 may be formed in arc or C-shape. However, the present general inventive concept is not limited thereto. That is, in alternative example embodiments, the series of protrusions 142 may be configured in various shapes and patterns so as to provide a surface which applies a sufficient amount of friction in order to effectively scrape debris from a user's tongue. In example embodiments, the tongue cleaner 140 may also be pre-coated with a tongue cleaner during a manufacturing process thereof.

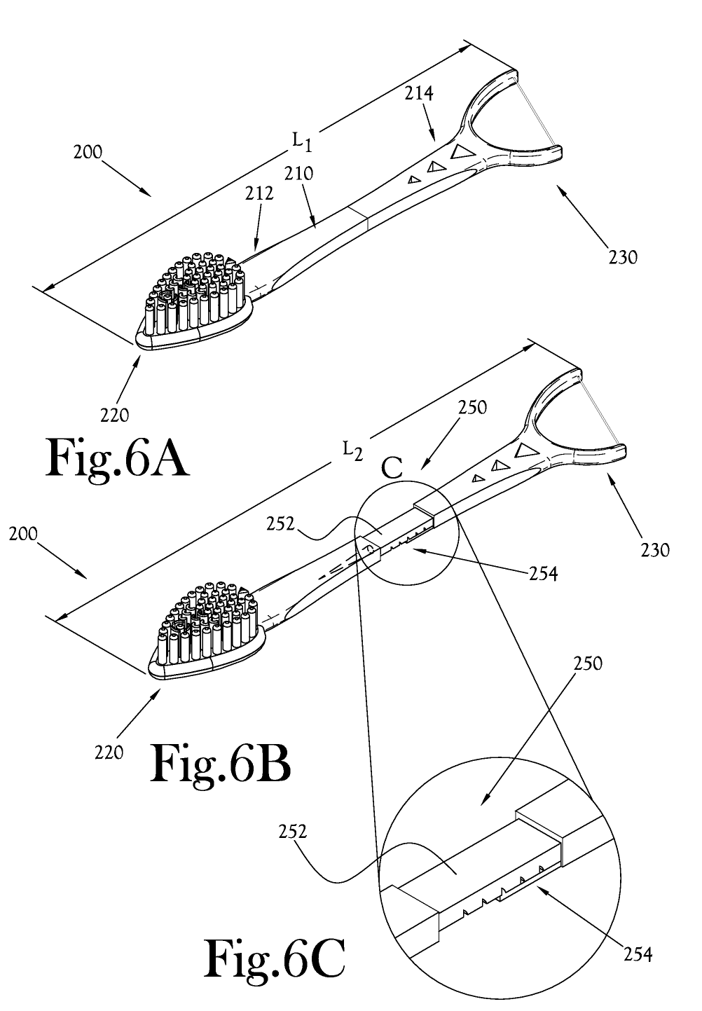

FIG. 5A is a partial cross-sectional view of a user's upper and lower sets of teeth 12a, 12b and a combined toothbrush and mouth care device 100 according to an example embodiment of the present general inventive concept. FIG. 5B is a partial cross-sectional view of the combined toothbrush and mouth care device 100 illustrated in FIG. 5A partially inserted into a user's upper and lower sets of teeth 12a, 12b and FIG. 5C is a partial cross-sectional view of the combined toothbrush and mouth care device 100 illustrated in FIG. 5A fully inserted into a user's upper and lower sets of teeth 12a, 12b.

Referring to FIGS. 5A-5C, a user may hold the grip portion 116 of the main housing member 110 and insert the brush head 120 within a user's mouth 10 having upper and lower sets 12a, 12b of teeth 12. The plurality of bristles 122 may initially contact and clean the user's anterior teeth 14 as the brush head 120 is inserted within the user's mouth 10.

As illustrated in FIG. 5B, the brush head 120 simultaneously and/or concurrently contacts and cleans the user's upper and lower sets 12a, 12b of teeth while brushing. As illustrated in FIG. 5C, the plurality of bristles 122 may then be inserted further into the user's mouth 10 and the brush head 120 may move aside the user's cheeks 18 and/or gums 20 in order for the bristles 122 to reach and properly clean the user's posterior teeth 16.

In the present example embodiment, the combined toothbrush and mouth care device 100 can be designed to allow a user to achieve a prime or optimal angle during brushing to effectively and efficiently clean both upper and lower sets 12a, 12b of teeth. In addition, the main housing member 110 can be designed to include a narrow portion to provide the user with a greater amount of control and maneuverability of the brush head 120 and/or the flossing member 130 within the user's mouth 10. As a result, the combined toothbrush and mouth care device 100 may reduce an overall amount of time required to brush all of the user's teeth 12 by increasing a surface area of teeth cleaned by the plurality of bristles 122 on each brushing stroke.

As illustrated in FIG. 5C, the second region 126 of the brush head 120 may wedge, fit, or squeeze within areas of the user's mouth in order to reach, contact, and clean the user's posterior teeth 16. That is, the width W5 in the second region 120b can be specifically designed so as to fit within an opening within the user's mouth such as between the user's teeth 12 and cheeks 18 to thereby gradually wedge or move the user's cheeks and/or gums aside to allow the plurality of bristles 122 to contact and clean deep within the user's mouth 10, while brushing.

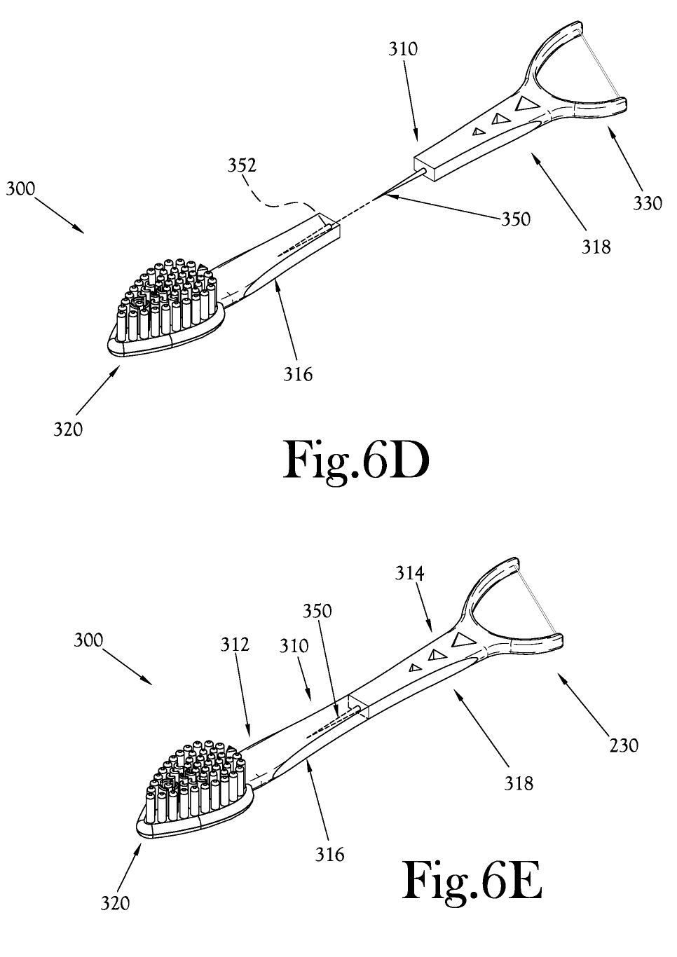

FIG. 6A is a front perspective view of a combined toothbrush and mouth care device 200 according to another example embodiment of the present general inventive concept, in a compressed state. FIG. 6B is a front perspective view of the combined toothbrush and mouth care device 200 illustrated in FIG. 6A, in an expanded state. FIG. 6C is an expanded detail view of item C illustrated in FIG. 6B.

Referring to FIGS. 6A-6C, the combined toothbrush and mouth care device 200 according to the present example embodiment also includes the elements and features described within the previous example embodiments. That is, the combined toothbrush and mouth care device 200 also includes a main body member 210 having a first end 212 and an opposing second end 214, a brush head 220 coupled to the first end 212 and a flossing member 230 coupled to the second end 214. In addition, the device 200 according to the present example embodiment further includes a telescoping member 250 disposed on the main housing member 210 to telescopically extend a longitudinal length of the main body member 210.

In example embodiments, the telescoping member 250 may include a rail member 252 and a latching member 254 which is slidably or movably coupled to the rail member 252. In example embodiments, the rail member 252 can be coupled to the first end 212 of the main body member 210 and the latching member 254 can be coupled to the second end 214 of the main body member 210. The telescoping member 250 allows a user to adjust an overall longitudinal length of the device 200. For instance, the user may pull on each end of the main body member 210 to expand the longitudinal length from a compressed state length L1 to an expanded state length L2 in order to further reach the user's posterior teeth 16, wherein the expanded length L2 is greater than the compressed length L1.

In example embodiments, the latching member 254 may further include one or more barbs 256 which may be used to temporarily lock or secure the mouth care device 200 in the expanded state and/or in the compressed state.

FIG. 6D is a front perspective view of a combined toothbrush and mouth care device 300 according to another example embodiment of the present general inventive concept, in an open state. FIG. 6E is a front perspective view of the combined toothbrush and mouth care device 300 illustrated in FIG. 6D, in a closed state.

Referring to FIG. 6D, the combined toothbrush and mouth care device 300 includes the elements and features described within the previous example embodiments. That is, the combined toothbrush and mouth care device 300 also includes a main body member 310 having a first end 312 and an opposing second end 314, a brush head 320 coupled to the first end 312 and a flossing member 330 coupled to the second end 314. In addition, the device 300 according to the present example embodiment further includes a tooth pick member 350 coupled to a portion of the main body member 310.

That is, in the present example embodiment, the main body member 310 is capable of being separated into a first portion 316 including the brush head 320 and a second portion 318 including the flossing member 330. As illustrated in FIG. 6D, the second portion 318 includes the tooth pick member 350 which may be used to pick and remove debris from between a user's teeth. The first portion 316 includes a tooth pick receiver 352 which may be used to receive or store the tooth pick member 350. The tooth pick receiver 352 may be configured to receive the tooth pick member 350 when not in use. The tooth pick receiver 352 may be shaped so as to guide the tooth pick member 350 into a secured closed position as illustrated in FIG. 6E. The tooth pick member 350 may be formed in various shapes in order to allow at least a portion of the tooth pick member 350 to fit between the user's teeth.

The present general inventive concept provides a disposable combined toothbrush and mouth care device having a brush head coupled to a proximal end of a main body member formed in a rounded triangular, diamond, or V-shape in order to allow the brush head to reach narrow areas within a user's mouth. The brush head may be shaped so as to allow a plurality of bristles attached to the brush head to easily reach and contact the user's posterior teeth.

The specifically designed diamond-like or v-shaped brush head includes a wider portion which includes a larger surface area and therefore accommodates a larger amount of bristles in order to increase an efficiency while brushing. In addition, specifically designed diamond-like or v-shaped brush head includes a narrower portion which allows the brush head to reach deeper or further back in the user's mouth to more effectively clean all areas within the user's mouth.

As a result, the combined toothbrush and mouth care device having a v-shaped brush head according to the present general inventive concept allows a user to more effectively and efficiently clean both anterior and posterior teeth. That is, the wider portion of the brush head can be configured, to allow the user to concurrently or simultaneously brush both top and bottom rows of teeth, during a single brushing stroke, to thereby clean a larger surface area of teeth during each stroke.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. A combined toothbrush and mouth care device, comprising:
a main body member having a proximal end and a distal end;
a brush head having a plurality of bristles to brush a user's teeth coupled to the proximal end of the main body member; and
a flossing member to floss between the user's teeth integrally formed with the distal end of the main body member,
wherein the brush head includes a first region having a first width and a second region having a second width less than the first width to reach the user's posterior teeth.

2. The combined toothbrush and mouth care device of claim 1, wherein the brush head is formed in a triangular shape.

3. The combined toothbrush and mouth care device of claim 1, wherein the first region of the brush head is configured to simultaneously contact upper and lower sets of teeth of the user.

4. The combined toothbrush and mouth care device of claim 1, wherein the second region of the brush head is configured to wedge within the user's mouth to contact the user's posterior teeth.

5. The combined toothbrush and mouth care device of claim 1, wherein the plurality of bristles are arranged in a pattern corresponding to a shape of the brush head.

6. The combined toothbrush and mouth care device of claim 1, wherein the plurality of bristles are coated with a cleaning agent.

7. The combined toothbrush and mouth care device of claim 1, wherein the plurality of bristles are disposed on a first surface of the brush head and a tongue cleaner is formed on an opposing second surface of the brush head.

8. The combined toothbrush and mouth care device of claim 7, wherein the tongue cleaner is coated with a cleaning agent.

9. The combined toothbrush and mouth care device of claim 1, wherein the flossing member includes a first arm member, a second arm member, and a dental floss coupled between the first and second arm members.

10. The combined toothbrush and mouth care device of claim 9, wherein the first arm member and the second arm member extend along an elliptical path centered on a centerline of the brush head and the main body member.

11. The combined toothbrush and mouth care device of claim 10, wherein the first arm member extends beyond a centerline of the elliptical path and the second arm member extends beyond a focal point of the elliptical path.

12. The combined toothbrush and mouth care device of claim 1, wherein the main body member is configured to separate into a first portion including the brush head and a second portion including the flossing member.

13. The combined toothbrush and mouth care device of claim 12, wherein the second portion includes a tooth-pick member capable of removing debris from between the user's teeth.

14. The combined toothbrush and mouth care device of claim 13, wherein the first portion includes a tooth-pick receiver configured to receive the tooth-pick member.
